(19) United States
(12) Patent Application Publication
(10) Pub. No.: US 2005/0144971 A1
(43) Pub. Date: Jul. 7, 2005

(54) Super energy efficient refrigeration system with refrigerant of nitrogen gas and a closed cycle turbo fan air chilling

(76) Inventor: Fikret M. Zabtcioglu, Bellevue, WA (US)

Correspondence Address: FIKRET ZEBTCIOGLU;CLIFF TERRACE APTS. # 8, 198 106TH AVE. SE, BELLEVUE, WA, 98004, US

(21) Appl. No.: 10/622,809

(22) Filed: Jul. 21, 2003

(51) Int. Cl. F17C 13/00; F25B 21/00; F25D 11/00

(52) U.S. Cl. 62/457.9; 62/440

(57) ABSTRACT

The primary purpose of this system is to have a refrigeration system that is super energy efficient that eliminates the dependency on the compressor. It also has a feature such as a special section of low moisture volume for ethnic foods or other perishables which are sensitive to moisture. The energy efficiency is made possible by utilizing cyrogenic nitrogen gas at −41 C in a container as the refrigerant that functions as a heat sink. Initially, the nitrogen gas is filled into this heat sink volume at a specific low temperature. Instead of being a circulated working gas refrigerant, which has to go through phase chages, the nitrogen gas always remains at the same gas state and at the same temperature. Same temperature is kept as a result of using an external air flow chilling effect, that is applied on thin rectangular prisms, by two fans that establish a fast air flow. The connection to the heat sink for the heat flow, is made by very thin copper cells that have special semi-heat conducting interfaces. These copper cells have gradually differing masses, that get larger as each one gets closer to the heat sink, and make up the internal walls of the fresh food volume. As a result, surface areas that face the volume that is to be cooled also differ in area for each cell. As a result of a combination of these different areas and interfaces between conducting cells, a certain temperature differential is kept, so that heat flow towards the heat sink is continous and no two cells reach thermal equilibrium. Heat sink absorbtion is without using a compressor, therefore it is much more energy efficient. Having a system that is made independent of compression-condensation cycles, through the use of the above mentioned structural cell heat flow, is what the invention presents as what is new in the art.

### CROSS REFERENCE TO RELATED APPLICATIONS

This application is related directly or indirectly to inventions described in U.S. Pat. No. 5,934,364 entitled; Cold plate dual refrigeration systems, and U.S. Pat. No. 5,038,574 entitled; Combined mechanical refrigeration and absorption refrigeration method and apparatus, and, U.S. Pat. No. 5,660,057 entitled; Carbon dioxide railroad car system, and U.S. Pat. No. 5,038,574 entitled; Combined and U.S. Pat. No. 5,660,057 entitled; Carbon dioxide railroad car refrigeration system, and U.S. Pat. No. 5,448,848 entitled; Non-CFC autocascade refrigeration system, and U.S. Pat. No. 5,323,622 entitled; Multi-temperature cryogenic refrigeration system.

Other U.S. Patent Documents
U.S. Pat. No. 4,248,060 February, 1981 Franklin, Jr. U.S. Pat. No. 4,404,818 September, 1983 Franklin, Jr. U.S. Pat. No. 4,457,142 July, 1984 Bucher. U.S. Pat. No. 4,593,536 June, 1986 Finketal. U.S. Pat. No. 4,704,876 November, 1987 Hill. U.S. Pat. No. 4,761,969 August, 1988 Moe. U.S. Pat. No. 4,766,732 August, 1988 Rubin U.S. Pat. No. 4,825,666 March, 1989 Saia, III U.S. Pat. No. 4,891,954 January, 1990 Thomsen. U.S. Pat. No. 4,951,479 August, 1990 Araquistain et al. U.S. Pat. No. 5,074,126 December, 1991 Mahieu. U.S. Pat. No. 5,152,155 October, 1992 Shea et al. U.S. Pat. No. 5,168,717 December, 1992 Mowatt-Larsen

### STATEMENT REGARDING FEDERALLY SPONSERED RESEARCH OR DEVELOPMENT

Not applicable.

### REFERENCE TO MICROFICHE APPENDIX

Not applicable

### BACKGROUND OF THE INVENTION

1. Field of the Invention

This present invention relates to refrigeration systems and more particularly, to a cryogenic refrigeration system, employing a combination of factors such as a refrigerant of Nitrogen gas and the Dewar high efficiency insulation, and a sequential heat flow cell connectivity, plus a turbo fan air chilling technology. Present invention can also be applicable as an auxiliary energy saving system for existing systems which use wide spread known refrigerants and have the classic compression and condensation cycle. It would achieve this by making the compressor to work for shorter times. In this way, it can retrofit to prior art technology, if this is preferred by industry.

The primary purpose of the invention is to eliminate the need for the compressor and to achieve a system without compression-condensation cycles.

2. Description of the Prior Art

In refrigeration systems, the major cost arises from using a compressor to compress adiabatically a refrigerant. Furthermore, the cost of of the compressor is a substantial part of initial cost of the system. Therefore, there is a need to have a system that would eliminate the initial as well as operating costs associated with the compressor-condensation cycle system that is not energy efficient.

As many units are energy inefficient, and since refrigerator is one of the highest energy consuming appliance globally, the multiplier effect creates a high energy total consumption, as it is used all over the world in households and commercial facilities and supermarkets and in shipping refrigerator units.

Compressor units use working gases that are not environment friendly. CFCs have to be abondoned due to the ozone damages it causes. F11 and F12 are banned in U.S., Canada and Sweden. Liquid Hydrocarbon refrigerants are known to be good refrigerants but these are flammable. Furthermore, because of the high pressures involved, leakages within systems occur.

The use of nitrogen as the refrigerant in various types of systems already exist in prior applications, but this system utiilizes nitrogen in a unique air flow chilling and structural heat flow connectivity system that maximizes the energy efficiency of using nitrogen gas as refrigerant, by keeping its low temperature stable. The difference of this system is that, the nitrogen is not the working refrigerant and is not circulated, but functions as a heat sink only. Instead of a working gas, the cells of heat flow connectivity system functions as a medium for heat flow towards the heat sink. Hence, the structural heat absorbtion and heat flow connectivity, replaces the function of the compression and condensation system.

Therefore, there is no need for compression and condensation cycles. Work is done by the fsan which chill the heat sink by a periodic fast air flow system.

### SUMMARY OF THE INVENTION

The present invention is a system that employs the principles of heat absorbtion and heat flow. In this sense, it is a classic heat engine of which the function is based on the temperature differentials between the two extreme temperature differential ends. With only one difference, this system does not use a working gas that has to go through phase changes.

It is an object of the invention to establish a heat flow mechanism based on temperature differentials, betrween one larger volume heat sink container, that contains nitrogen gas and several metal—copper or other suitable highly heat conductive cells that are connected to each other, in order to establish a mechanism for heat flow through metal medium, instead of a gas refrigerant that runs in pipes.

In accordance with the preffered embodiment of the present invention as described herein, copper cells keep different eigen temperatures with thin connective interfaces, which is a function of the differences of mass of each cell itself, as well as a function of surface areas differences, that face the volume that is to be cooled. The result is a temperature differential that enable heat transfer from one cell to the another. The nitrogen gas within the heat sink larger volume stays in its container and does not propagate to any other volume. This heat sink that is periodically cooled by a turbo electric fan, is in an enclosed volume and functions as the heat sink, that utilizes and re-circulates the cold air from within the freezer section. The work done, is the is the work done by the closed cycle turbo cooling fan, that keeps one larger volume capacity nitrogen container as a low temperature heat sink. The work done by the turbo fan chiller consumes much less energy, in comparison to a compressor.

It is another important object of the invention to keep the low temperature, by using the Dewar-thermos principle as a strong middle section insulation means.

The result is that the larger capacity volume with low temperature nitrogen gas is kept at a specific low temperature and heat flows to this volume.

It is the main objective of the invention to have a very high energy efficient refrigeration by completely eliminating the compression and condensation cycles of prior art. The increase in efficiency is an operation energy of about one half the energy in Kw per hour, per year that a state of the art 21.9 Cubic feet refrigerator consumes. By law, begining Jul. 1, 2001, manufactured referigerators had to be 30% more energy efficient than the standards of 1993. This means, achieving one half the yearly energy consumption of a refrigerator that consumes 500 Kw hour per year, based on the 2001 standards, that is about 250 Kw hour per year. This is a much better standard, even better than the state of the art standard established by the Department of Energy.

The liquid nitrogen container keeps the gas nitrogen in its own volume, at gas phase all the time. It solves inefficiencies associated with propagating a refrigerant gas with a compressor—as metal surrounding the gas nitrogen facilitates heat conduction better than a gas medium. Each of the other cells remain at a different temperature range with minimum variation, which provides a differential of more than 4 C. As a result of this series of temperature differentials between one cell, to the other, a heat flow is generated from the relatively hot to the colder side. The work done, is the is the work done by the closed cycle turbo cooling fan, that keeps the larger volume capacity nitrogen container at low temperature heat sink. The work done by the turbo fan chiller consumes much less energy, in comparison to a compressor—as it is sufficient to have it to function on an on and off basis, with about one half the energy consumption of a compressor-condensation system

### BRIEF DESCRIPTION OF THE DRAWINGS

FIG. 1 is a cross sectional view as seen from behind the refrigerator, of the entire refrigerator system, showing the relative locations of the rerigerant volumes—the surface contact areas 15a to 19a, with the volume that is to be refrigerated and the closed cycle turbo cooling fan with its air flow pipe connection from the freezer section.

Due to shematic representation fresh food volume 23, is depicted smaller than it is. The space in which fan 39 is, 29a are not visible from this angle.

FIG. 2 is the same cross sectional view as FIG. 1, which shows the heat absorbtion cells and the heat sink 14, and the heat flow direction towards the heat sink.

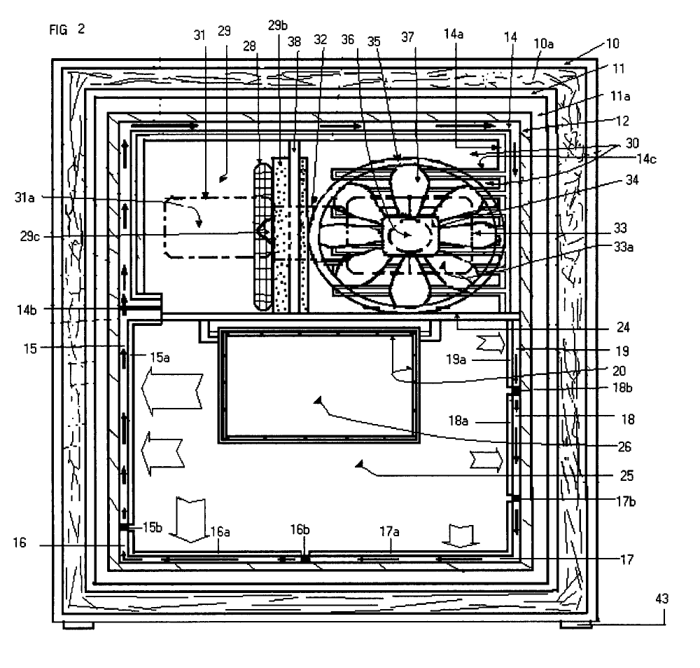

FIG. 3 is an exploded perspective view of the closed cycle chilling fan and of the rectangular prisms that are part of the heat sink container. Along the X axis.

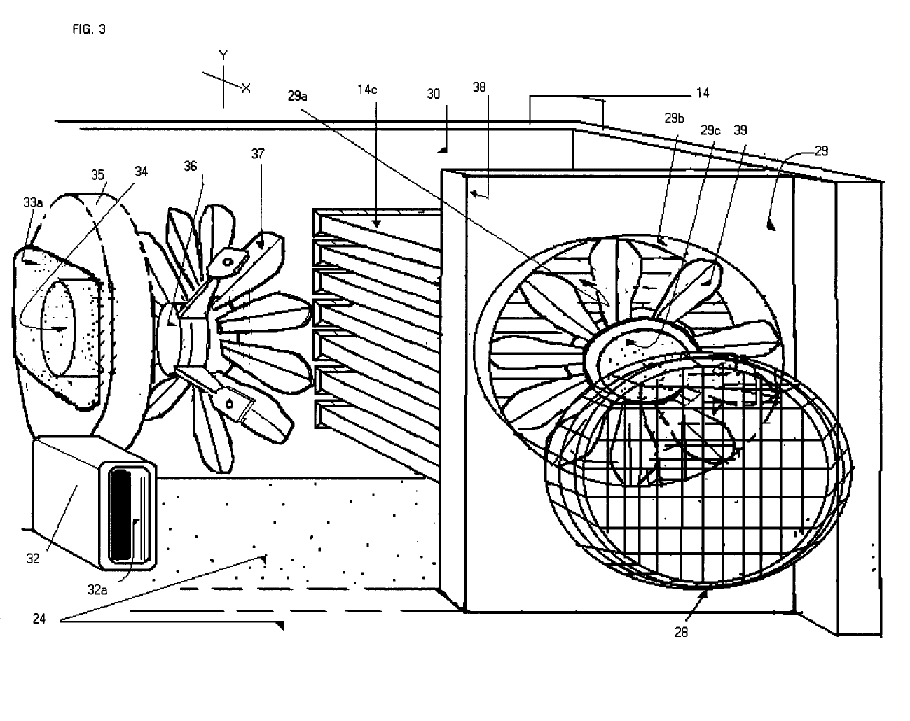

As seen from the inside of volume 29. Note, the wall 38, that seperates freezer sections 29 and 30 is depicted only in half. The pipe curvature of 31a, connects to air pass pipe 32.

FIG. 4 is an enlarged schematic representation of the partial heat conduction of the interface between cells 15 and 16. Which is 15b.

As seen from the inside of volume 29. Note, the wall 38, that seperates freezer sections 29 and 30 is depicted only in half. The pipe curvature of 31a, connects to air pass pipe 32.

FIG. 5. is a plan view of the upper two freezer sections, one of which is the chilling volume 30, in which the rectangular prisms are.

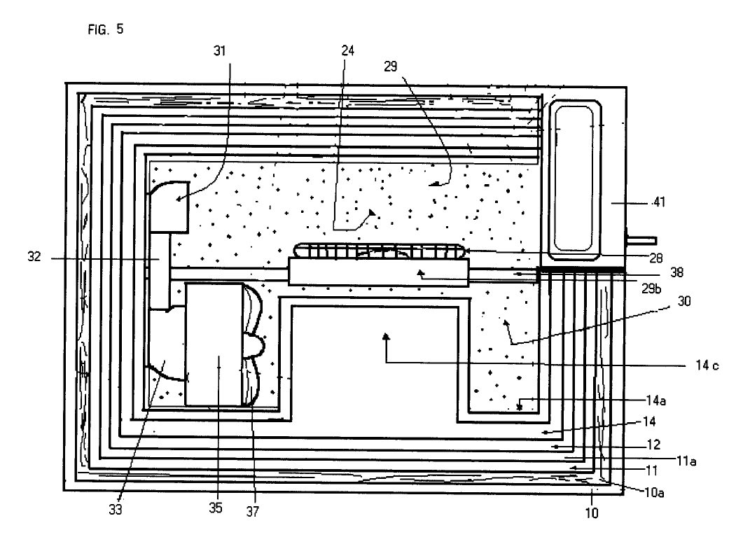

FIG. 6 is a plan view of the airflow that occurs between the two section freezer.

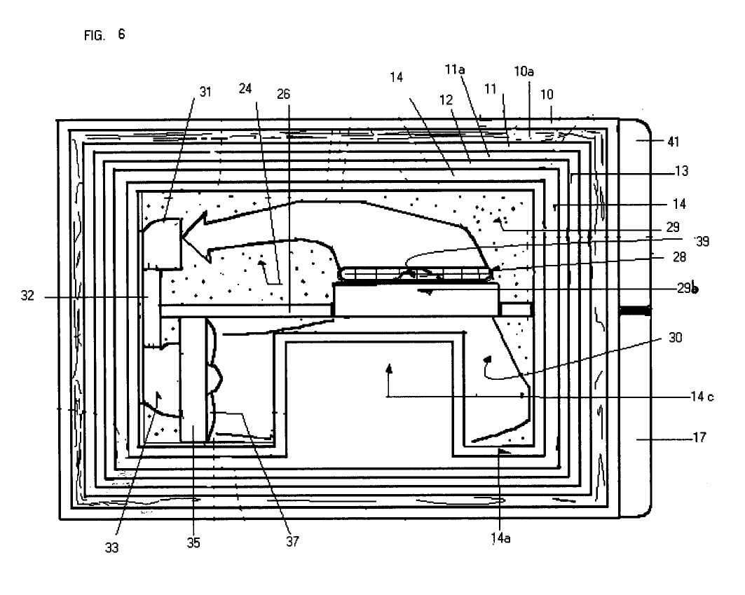

FIG. 7 is a front view, left side hatched perspective, showing freezer 29.

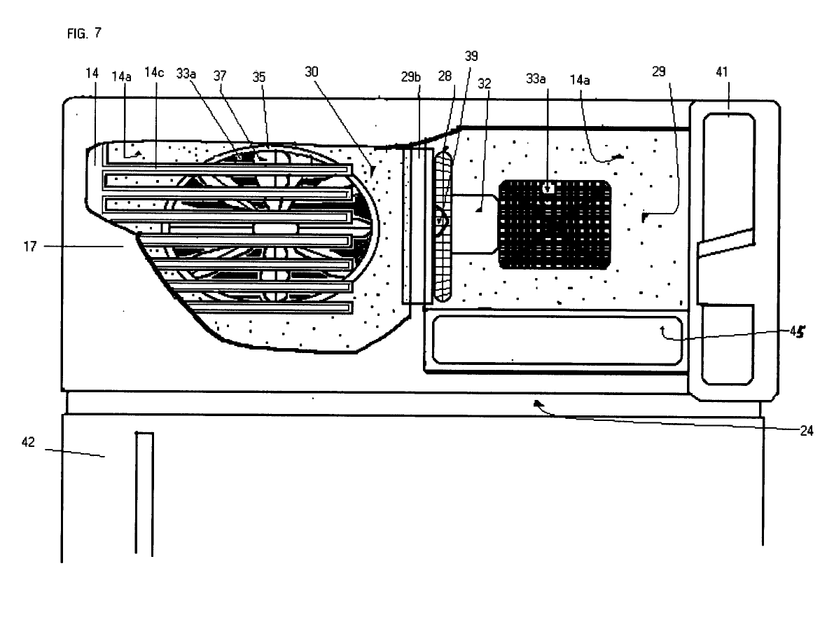

FIG. 8 is a front perspective view of the heat conduction volumes structure, insulation frames not shown. Rectangular prisms in volume 30 and freezer section 29.

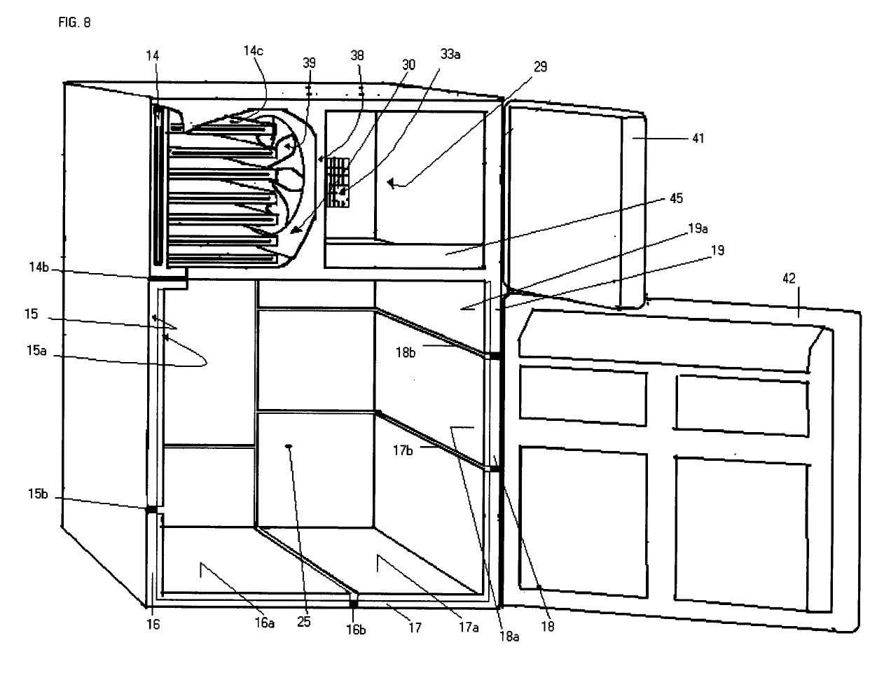

FIG. 9 Shows relations between per energy unit—energy consumption and efficiency.

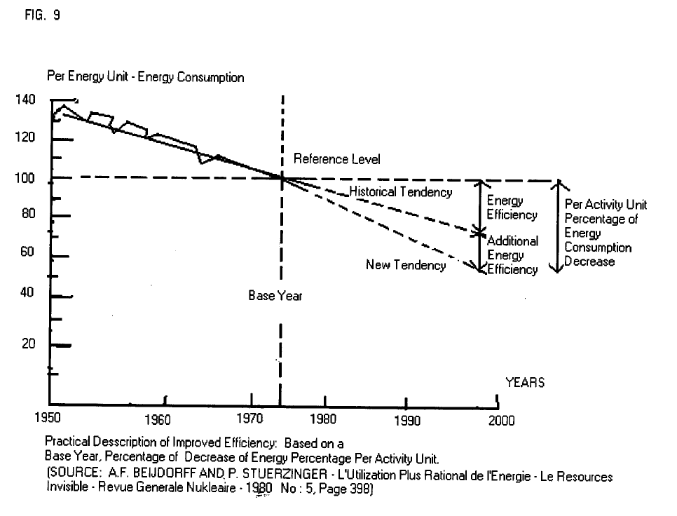

### DETAILED DESCRIPTION OF THE INVENTION

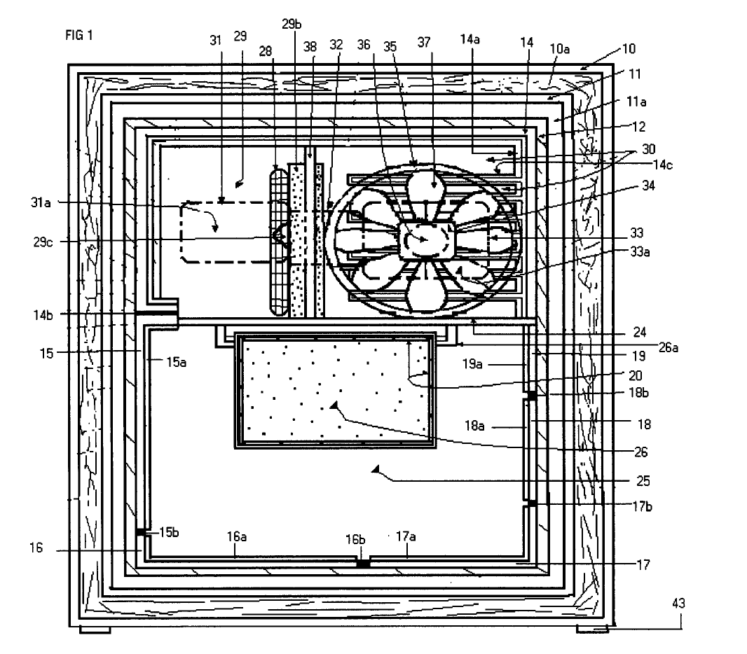

FIG. 1 illustrates in a detailed schematic view, the complete system as seen from the back side of the refrigerator, with all the different components that make up the system: The external frame 10, all five sides, the external insulation material within this frame 10a, external wall of Dewar 11, the Dewar air vacuumed layer 11a, internal wall of Dewar 12, also being the second internal insulation 12, the one large refrigerant nitrogen gas volume 14, and the thin heat conduction layer 14a. Copper heat flow cells 15, 16, 17,18, 19.

The mass differences between the cells are: Cell 18=1.5×19, cell 17=1.5×18, cell 16=1.5×17, cell 15=1.5×16. So, these heat conductive cells get larger and larger, the closer these get to the heat sink. These conduction cells are thin and are made of material of minimal resistance to heat conduction, heat absorbtion surfaces are twice thin, relative to thickness of conduction cells. Conduction cells are thin to facilitate heat flow despite the total length of all cells, the total distance upto the heat sink.

All have a corresponding inner side thin absorbtion surface, which face the fresh food volume, which absorb heat from the fresh food volume, and which act as internal area heat absorbtion surfaces, 14a—freezer volume, 15a, 16a, 17a, 18a, for fresh foods volume and these are on those sides that face the internal volume fresh foods section 25. Absorbtion surfaces are in direct metal surface area contact with their corresponding conduction cells.

Each cell, also has a corresponding cell interface in between. One between the heat sink container 14, and the first heat conducting cell 15, is 14b, between cell 15 and cell 16 is 15b, between cell 16 and cell 17 is 16b, between 17 and 18, is 17b, between 18 45 and 19, is 18b.

Each of these five interfaces, have such a thermal conductivity property that, these serve the purpose to keep a −5 C difference, between every two adjacent cells. The internal fresh food volume 25, the ceramic volume 26, with ceramic tiles 20, holders of 26, 26a, freezer section seperation wall 24, that seperates it from the lower fresh foods volume 25, the wall 38, that seperates the fan chilling area 30, from the freezer volume 29, closed cycle turbo fan electric motor 36, the cold air closed cycle entry openning 31, to the connection air flow pipe 32, which takes cold air at −39 C from the freezer volume 29, to the fan that has a highly efuicient electric motor 36, and fan propeller that is made of plastic material 37, cold air pass through the entry to fan openning 33a, moves between the nitrogen gas prisms 14c, that are infront of the fan propeller 37, and are cooled by this fan propeller 37, the air flow gaps 30, which is part of overall volume 30, between nitrogen gas rectangulars 14c, through which chilling air flow between these nitrogen panels 14c, the freezer door 41, lower fresh food volume door 42, legs on which the refrigerator stands 43.

Operation of the energy efficient refrigeration system is as follows: The nitrogen gas in the larger volume capacity nitrogen gas container 14, which has been filled into this container at the production site, at an initial temperature of −41 C, is kept at the same temperature, by chilling it periodically by a turbo fan propeller 37, repeatedly, right after the refrigerator is made functional on order. This temperature of −41 C, establishes a treshold for the high efficiency chilling function, for it makes the volume 29 temperature to stand at −39 C.

The preparation of the system before it is shipped to the customer, requires only two steps: 1. Filling in the cyrogenic nitrogen gas at −41 C into volume 14c, 2. Starting the fan chilling function. Because system is to be made to order, an optimal inventory is kept, therefore it is also more feasible in terms of optimal inventory and energy efficiency at production site, which is not mass production but made to order.

Freezer Internal Air Flow and Chilling of the Nitrogen Refrigerant Part of the already cold air at −39 C is taken out from one side of the freezer section 29, and passes through an opening 31a, and pipe curvature 31, that connects to pipe 32, and second opening 33a, and is blown between the thin prisms 14c, of which the total area makes an enlarged area.

Due to this extremely low temperature, the fan electric motor 36, is protected in an insulated protective box 34.

The work done, is the work done by the closed cycle turbo cooling fan 37, and the air flow facilitator fan 39, that keeps one larger volume capacity nitrogen container 14, as a low temperature heat sink. The work done by the turbo fan chiller 37, and air flow facilitator 39, consumes one half the energy that a compressor consumes to achieve said low temperatures. This is made possible by the frequent, but non-continous runing of the fans 37 and 39. Without the wind chilling, the boundary layer (still air)—which is part of volume 30, of each prism stands at −39 C, while temperature of the nitrogen gas prisms in volume 14c, is at −41 C. Hence, the constant heat gain from the volume 30, to the nitrogen prisms 14c, by conduction would be slow, but after a long time, it would result in thermal equilibrium. With increased air flow, however, this is not the case and the boundary layer is reduced in thickness to a near zero boundary layer, and instead of heat gain, heat loss occurs.

These rectangular prisms 14c, are 40% of the total nitrogen gas volume 14. The enlarged external surface area in the form of thin rectangular prisms, 14c is for the periodic wind chill application to be effective based on this larger area.

The sum of the area of the internal walls of volume 30, is three times the area of a prior art 45 freezer, because of the extra area the prisms makes. Volume 30, can not be used as a freezer, the sole function of this volume is to facilitate the chilling of the nitrogen gas within the prisms and to stabilize the low temperature of the heat sink 14.

On top and bottom of rectangulars are air flow gaps—which are part of volume 30, seven of these prisms 14c, fit in a small volume, in comparison to the total surface area, of these prisms 14c, because these thin prisms are one on top of another and the gaps between them are narrow.

Thereby, the fan 37, subjects all prisms 14c, to a wind chill equivalent temperature of −62 C, periodically. Both the top and bottom sides of each prisms 14c, is subject to wind chill, and the wind chilling fast air flow pass above and below each prism 14c. Thereby, prisms 14c, maximizes subject area of exposure, to wind chill of −62 C.

The nitrogen gas within this heat sink volume 14, is kept at −41 C, as a result of the periodic chilling effect that the fan 37, creates. The diferential between −62 C and the nitrogen prism 14c, surface temperature −39 C, is a difference of 23 degrees C. That is, the air flow generated blows at a temperature of −62 C, this is 23 degrees lower than the surface temperature—boundary layer temperature—of prisms 14c. Fan 37, utilizes the already cold temperature air at −39 C of the freezer section 29.

Thereby, the temperature of the nitrogen gas is kept at −41 C, within its larger volume capacity nitrogen container 14. When it is running and blows, it takes the −39 C air from volume 29, and blows it at a wind speed of 6 meters per second and fast re-circulates it within the enclosed volumes of freezer sections 29 and 30. Since the depth of the refrigerator is only about 2 meters for even large capacity refrigerators, whereas the wind speed created by the fan is 6 meters per second, in order to avoid a back pressure problem, an air flow facilitator fan 39, is utilized, that is located within the wall 38, which seperates the two freezer sections 29 and 30.

Fan 37, together with fan 39, both run concurrently in order to facilitate an air flow with minimum back pressure and air turbulance. This is possible, as the air flow facilitator fan 39, creates a vacuum effect, out of volume 30, by blowing the air at a speed greater and to an opposite direction, into volume 29 than the incoming direction. That is, it blows the air at 7 meters per second, out of freezer volume 30, into freezer section 29.

This speed difference of the propeller 39, creates an internal air flow with minimum backpressure. Since the turbo chilling fan 37, also creates a vaccuum effect—out of volume 29, a fast circulation of air is realized. Thereby, backpressure against turbo fan propeller 37, is avoided.

Thus, a non-continous, but periodic turbo fan chilling, which produces a wind chill equivalent of −62 C periodically, that keeps the refrigerant gas nitrogen-heat sink part 14, at −41 C.

It can achieve this with about one half the energy that a compressor consumes per year, that a comparable size refrigerator consumes, to achieve such low temperatures. Therefore, this volume 14, functions as a heat sink with high energy efficiency.

Temperature Differences Between The Heat Sink And The Other Cells The temperature difference between the one extreme, the heat sink 14, at −41 C and the cell 19, at −5 C, at the other end of the heat conducting cells, is 36 degrees C.

These cells are connected through the heat flow interfaces 14b, 15b, 16b, 17b, 18b, and absorb heat out of the inner fresh food volume 25. The highest temperature cell 19, reaches the highest temperature of −5 C. An average temperature of −5 C is to be kept within the inner fresh food volume 25.

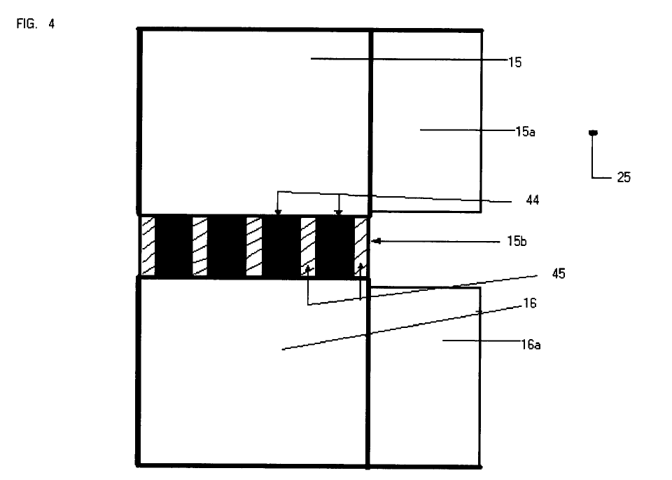

This differential of 5 C between each cell is kept by allowing a controlled heat flow. The 5 C degree difference between each cell is created by: a) Some cells that have smaller absorbtion area, 17a, 18a, 19a and others 15a, 16a, with larger internal area heat transfer surfaces facing the volume 25, that is to be cooled, and b) Partial controlled heat conduction by thin and highly conductive cylinders 44—minimal blocking of the heat flow by thin non-conductive adjacent thin membrane 45. That is, each of the interfaces 14b, 15b, 16b, 17b, 18b, consists of small and short, highly conducting micro cylinders 44, and adjacent thin non conducting membranes 45, which are between every two thin cells, as shown in FIG. 4.

As a result, no two adjacent two cells reach thermal equilibrium. Each one keeps a 5 C degree differential all the time. This figure is not exact—actual values may be different.

At −41 C degrees stabilized, the nitrogen gas does not create a pressure increase problem due to thermal expansion. However, the pressure temperature diagram and phase transition properties of nitrogen shows, nitrogen has a great tendency to have pressure increase as temperature rises above a treshold.

But pressure safety can be secured due to following: Total volume of the container relative to volume of the nitrogen gas placed in it, is in such exact proportionality that, even if both fans stop running, the container 14, has sufficient room for the expansion of the nitrogen gas. Furthermore, the very strong insulation would make it impossible for the nitrogen gas to warm up suddenly. System has such a strong insulation that, based on its insulation parameters, it takes at least 168 hours for the internal temperature at the freezer section, where the nitrogen heat sink 14 is located, to reach thermal equilibrium with the external ambient temperature, if during the entire period of 168 hours, the fans do not run, the doors are closed, and external ambient temperature is 23 C.

### THE BEST MODE FOR CARRYING OUT THE INVENTION

The nitrogen gas volume container 14, functions as a heat sink. Since the structure of the refrigerator is strongly insulated by the utilization of the Dewar insulation 11a, plus two layers of insulating materials—external insulation 10a, internal insulation 12, the cold air within volumes 25, 26, 29, 30, are completely insulated from exterior ambient temperature in terms of heat conduction. The only warmer air inflow occurs, when either the fresh food volume door 42, or the freezer volume door 41, is openned.

As internal cooling through insulation is made stable, the turbo fan 37, and the air flow facilitator fan 39, create a closed cycle periodic chilling air flow, which keeps the heat sink 14, at a low temperature stable.

The internal walls of the fresh food volume 25, face heat absorbtion surfaces 15a, 16a, 17a, 18a, that are the highly heat conducting internal surface areas of the cells 15, 16, 17, 18, 19, respectively.

That is, these cells 15, 16, 17, 18, 19, are made of different mass units, which is a result of their different lengths—which as a consequence, have different heat absorbtion areas that face the fresh food volume 25.

Since quantity of heat flow is proportional to area, the differences in area of each unit, results in a difference in temperature for each cell, as a result of different rates of quantity of heat absorbtion that each other one cell area absorbs.

This also means that, these heat flow cells are asysmmetric because of their different lengths. The asymmetry also propagates, as every adjacent cell has a different length, and it makes the heat flow cells to be asymmetric relative to the structural external uniform frame. For example, relative to the second internal insulation frame 12, in FIG. 1.

Between each cell, there is one heat flow interface 15b, 16b, 17b, 18b. These interfaces are such that, the heat flow that each allow, is a controlled partial flow and minimal heat flow blocking. The minimal blocking of the heat flow is achieved by these interfaces: 14b, 15b, 16b, 17b, 18b. The structural and material make of these interfaces have: a) Non conducting membrane within and, b) Thin, but highly heat conductive short cyclinder micro copper connections. The heat flow sequence direction is: 18b, 17b, 16b, 15b, 14b. The purpose of this is to keep a minimum 5 C difference between any two neighboring cells, so that any two cells never reach a thermal equilibrium condition. The units 15, 16, that are closer to the heat sink have lower temperatures.

As the difference is kept, the heat flow continuity is not interrupted and proceed towards the heat sink 14, from one warmer cells to the one that is colder. Therefore, the relative temperature differertials relation between all these heat flow cells are:

$${T}_{14} ⪡ {T}_{15} < {T}_{16} < {T}_{17} < {T}_{18} < {T}_{19} .$$

Each temperature decrease between each copper cell, starting from 19, towards the heat sink container 14, is not at same rate as shown above. Between 19 and 18, the difference is 5 C degrees. Between 18 and 17, it is 5 C. Between 17 and 16, it is 5 C, between 16 and 15, it is 5 C, but between 15 and heat sink 14, it is 16 C. These differentials add up to 36 C degrees as the sum of difference between heat sink 14c and cell 19. This is the sum of the highest temperature cell,at −5 C,being cell 19, and heat sink 14, at −41 C.

For a 21.9 Cubic feet household refrigerator, the sum of the two vertical side walls and bottom horizontal wall total length inclusive the cell 19, to the heat sink 14, is 2.2 meters. For larger commercial refrigerators, for example supermarket refrigerators, this distance increases by a factor of 2 for mid size supermarket refrigerators.

This system can be applied to very large supermarket refrigerators, if the length proportions of the conducting cells are adjusted accordingly and the heat sink is bigger and its temperature is considerably lower than −41 C degrees.

1. A cyrogenic refrigerator capable to run with one half the energy, that the latest state of the art 21.9 cubic feet technology household refrigerators consume,

2. A cyrogenic refrigerator according to claim 1, where the work done is not based on a compressor and therefore associated vibration and problems related to compressed environmentally hazardous refrigerants are completely avoided,

3. A cryrogenic refrigerator according to claim 1, where part of the frezeer section volume consists of:
Rectangular prisms in one half part of the total volume of freezer sections, that are part of the external boundaries of a non-circulated nitrogen gas volume container, that functions as a heat sink, as a result of being effectively chilled on a regular basis and kept at a low temperature stable by two fans that create a fast internal air flow.

4. According to claim 3, wherein the metal surrounding the gas nitrogen facilitates a better heat sink than pipes with a compressed gas medium, and consists of:
A container with a boundary connection that is highly heat conductive, to which the heat absorbtion cells are connected that are metal—copper that absorb and conduct heat better than a gas refrigerant that has to go through phase changes,

5. Based on the method of claim 4, where the heat absorbtion from the fresh foods section results in a −5 C degree stable within fresh foods volume,

6. The method of claim 5, where system achieves a stable temperature at −5 C degrees, that is similar to a natural environment, within volume 25 overall, in terms of other non-temperature variables like moisture level, as well as elimination of static electric accumulation and current leakage, especially in one volume, within volume 25, consisting of:
A volume of which all inner surface area walls are covered with special thin ceramic tiles.
This volume 26, is within volume 25, it has its own closure and is only 25% of volume 25.
This volume is also removeable like a box.

7. According to claim 3, with stronger insulation, same system that is based on same principles, is capable to run with one half the energy consumption, that state of the art middle size supermarket refrigerators consume, by enlarging the lengths and consequentially the mass of each conducting cell with same proportions and by having interfaces that have higher rate conduction and having a bigger heat sink, of which the initial nitrogen filling temperature starts off and is kept considerably lower than −41 C degrees.
